(19) United States
(12) Patent Application Publication
(10) Pub. No.: US 2025/0118480 A1
(43) Pub. Date: Apr. 10, 2025

(54) MAGNETIC CORE STRUCTURE

(71) Applicant: LITE-ON Technology Corporation, Taipei City (TW)

(72) Inventors: Han-Min HUANG, Taipei City (TW); Chen CHEN, Taipei City (TW)

(21) Appl. No.: 18/792,602

(22) Filed: Aug. 2, 2024

Related U.S. Application Data
(60) Provisional application No. 63/588,303, filed on Oct. 6, 2023.

(30) Foreign Application Priority Data
Jun. 7, 2024 (TW) 113121215

(51) Int. Cl. H01F 27/26; H01F 27/30

(52) U.S. Cl. CPC H01F 27/263; H01F 27/306

(57) ABSTRACT

Disclosed is a magnetic core structure, which includes a magnetic frame body and a winding column. The magnetic frame body includes a first frame. The winding column is disposed in the magnetic frame body and includes a first magnetic column, a second magnetic column and a third magnetic column. The second magnetic column is disposed between the first magnetic column and the third magnetic column. A cross-sectional area of the second magnetic column is smaller than a cross-sectional area of the first magnetic column and a cross-sectional area of the third magnetic column. A projected area of the first magnetic column on the first frame covers a projected area of the second magnetic column on the first frame, and a projected area of the third magnetic column on the first frame covers the projection area of the second magnetic column on the first frame.

### CROSS REFERENCE TO RELATED PRESENT DISCLOSURE

This application claims the priority benefit of U.S. Provisional Application Ser. No. 63/588,303, filed on Oct. 6, 2023, and Taiwan Patent Application Serial Number 113121215, filed on Jun. 7, 2024, and the full disclosures of which are incorporated herein by reference.

### TECHNICAL FIELD

The present disclosure relates to a magnetic core structure, and in particular to a magnetic core structure that enables a magnetic component (i.e., an inductor) to provide different inductance characteristics corresponding to the bias currents when the magnetic core structure applied to the magnetic component.

### RELATED ART

A magnetic component, such as an inductor, is a passive electronic component which resists changes in electric current passing through it. Therefore, the winding and core structure of the magnetic component can be designed through relevant parameters such as current, voltage and/or frequency based on the application environment, product structure, shape or use of the magnetic component.

In the design of existing inductors, as the DC bias current increases, the inductance value of the existing inductor usually drops sharply at a certain bias current, and then continues to be reduced, so that existing inductor usually only provides a single inductance characteristic corresponding to the bias currents, which cannot meet different usage scenarios.

Therefore, how to provide a magnetic core structure that can enable a magnetic component (i.e., an inductor) to provide different inductance characteristics corresponding to the bias currents when the magnetic core structure is applied to the magnetic component is an urgent development trend for those skilled in the art.

### SUMMARY

Embodiments of the present disclosure provide a magnetic core structure that can solve the problem that the existing inductor usually only provides a single inductance characteristic corresponding to the bias currents, which cannot meet different usage scenarios.

The present disclosure provides a magnetic core structure, which includes a magnetic frame body and a winding column. The magnetic frame body includes a first frame. The winding column is disposed in the magnetic frame body and includes a first magnetic column, a second magnetic column, and a third magnetic column. The second magnetic column is disposed between the first magnetic column and the third magnetic column. A cross-sectional area of the second magnetic column is smaller than a cross-sectional area of the first magnetic column and a cross-sectional area of the third magnetic column. A projected area of the first magnetic column on the first frame covers a projected area of the second magnetic column on the first frame, and a projected area of the third magnetic column on the first frame covers the projected area of the second magnetic column on the first frame.

In the embodiments of the present disclosure, through the special structural design of the winding column (that is, the second magnetic column is disposed between the first magnetic column and the third magnetic column, the cross-sectional area of the second magnetic column is smaller than the cross-sectional area of the first magnetic column and the cross-sectional area of the third magnetic column, the projected area of the first magnetic column on the first frame covers the projected area of the second magnetic column on the first frame, and the projection area of the third magnetic column on the first frame covers the projected area of the second magnetic column on the first frame), when the magnetic core structure is applied to the magnetic component (i.e., inductors), the magnetic component can provide different inductance characteristics corresponding to the bias currents to meet different usage scenarios.

### BRIEF DESCRIPTION OF THE DRAWINGS

Accompanying drawings described herein are intended to provide a further understanding of the present disclosure and form a part of the present disclosure, and exemplary embodiments of the present disclosure and descriptions thereof are intended to explain the present disclosure but are not intended to unduly limit the present disclosure. In the drawings:

FIG. 1 is a perspective view of a magnetic component according to a first embodiment of the present disclosure;

FIG. 2 is a cross-sectional view of the magnetic component of FIG. 1 along line AA′;

FIG. 3 is a cross-sectional view of a magnetic core structure according to an embodiment of the present disclosure;

FIG. 4 is a cross-sectional view of a magnetic core structure according to another embodiment of the present disclosure;

FIG. 5 is a graph of inductance value of the magnetic component of FIG. 1 versus bias current;

FIG. 6 is a perspective view of a magnetic component according to a second embodiment of the present disclosure;

FIG. 7 is a cross-sectional view of the magnetic component of FIG. 6 along line BB′;

FIG. 8 is an exploded view of the magnetic component of FIG. 6;

FIG. 9 is a graph of inductance of the magnetic component of FIG. 6 versus bias current;

FIG. 10 is a perspective view of a magnetic component according to a third embodiment of the present disclosure;

FIG. 11 is an exploded view of the magnetic component of FIG. 10;

FIG. 12 is a perspective view of a magnetic component according to a fourth embodiment of the present disclosure; and

FIG. 13 is an exploded view of the magnetic component of FIG. 12.

### DETAILED DESCRIPTION OF THE EMBODIMENTS

The embodiments of the present disclosure will be described below in conjunction with the relevant drawings. In the figures, the same reference numbers refer to the same or similar components or method flows.

It must be understood that the words “including”, “comprising” and the like used in this specification are used to indicate the existence of specific technical features, values, method steps, work processes, elements and/or components. However, it does not exclude that more technical features, values, method steps, work processes, elements, components, or any combination of the above can be added.

It must be understood that when an element is described as being “connected” or “coupled” to another element, it may be directly connected or coupled to another element, and intermediate elements therebetween may be present. In contrast, when an element is described as “directly connected” or “directly coupled” to another element, there is no intervening element therebetween.

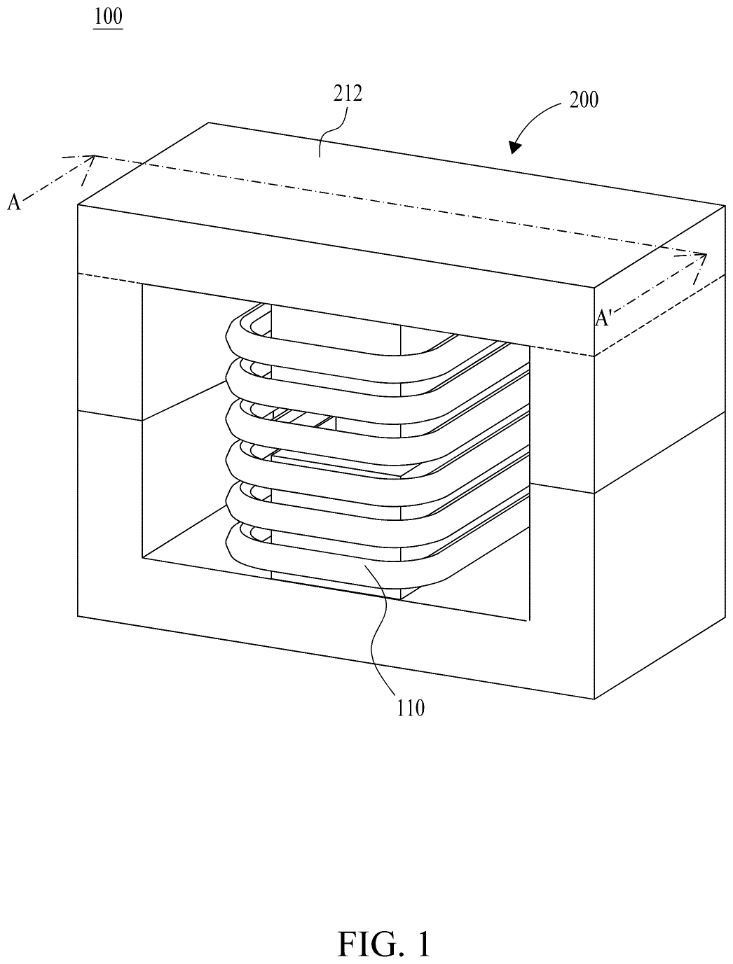

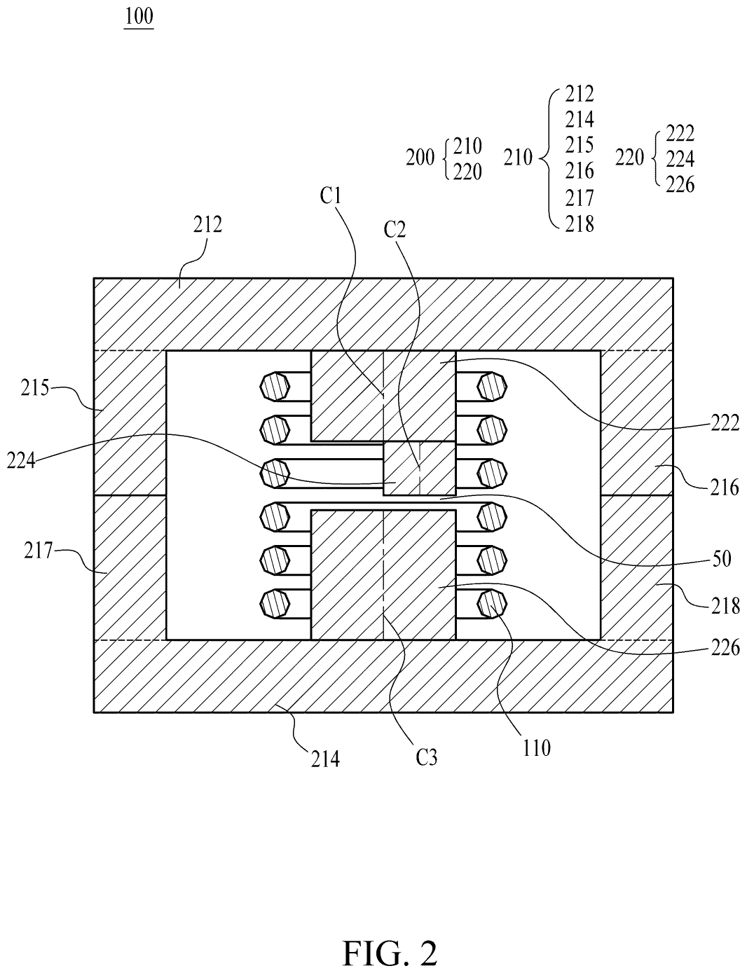

Please refer to FIG. 1 and FIG. 2. FIG. 1 is a perspective view of a magnetic component according to a first embodiment of the present disclosure, and FIG. 2 is a cross-sectional view of the magnetic component of FIG. 1 along line AA′. As shown in FIG. 1 and FIG. 2, a magnetic component 100 comprises a winding 110 and a magnetic core structure 200, wherein the magnetic component 100 may be, but is not limited to, an inductor, and the winding 110 may be, but is not limited to, made of a flat copper wire or a round copper wire.

The magnetic core structure 200 comprises a magnetic frame body 210 and a winding column 220. The magnetic frame body 210 comprises a first frame 212. The winding column 220 is disposed in the magnetic frame body 210 and comprises a first magnetic column 222, a second magnetic column 224 and a third magnetic column 226. The second magnetic column 224 is disposed between the first magnetic column 222 and the third magnetic column 226. A cross-sectional area of the second magnetic column 224 is smaller than a cross-sectional area of the first magnetic column 222 and a cross-sectional area of the third magnetic column 226. A projected area of the first magnetic column 222 on the first frame 212 covers a projected area of the second magnetic column 224 on the first frame 212, and a projected area of the third magnetic column 226 on the first frame 212 covers the projected area of the second magnetic column 224 on the first frame 212. The magnetic frame body 210 and the winding column 220 may be made of, but are not limited to, the same material, such as manganese-zinc ferrite, nickel-zinc ferrite and other high magnetic permeability materials. The relative magnetic permeability of the high magnetic permeability material may be, but is not limited to, 900 to 4000.

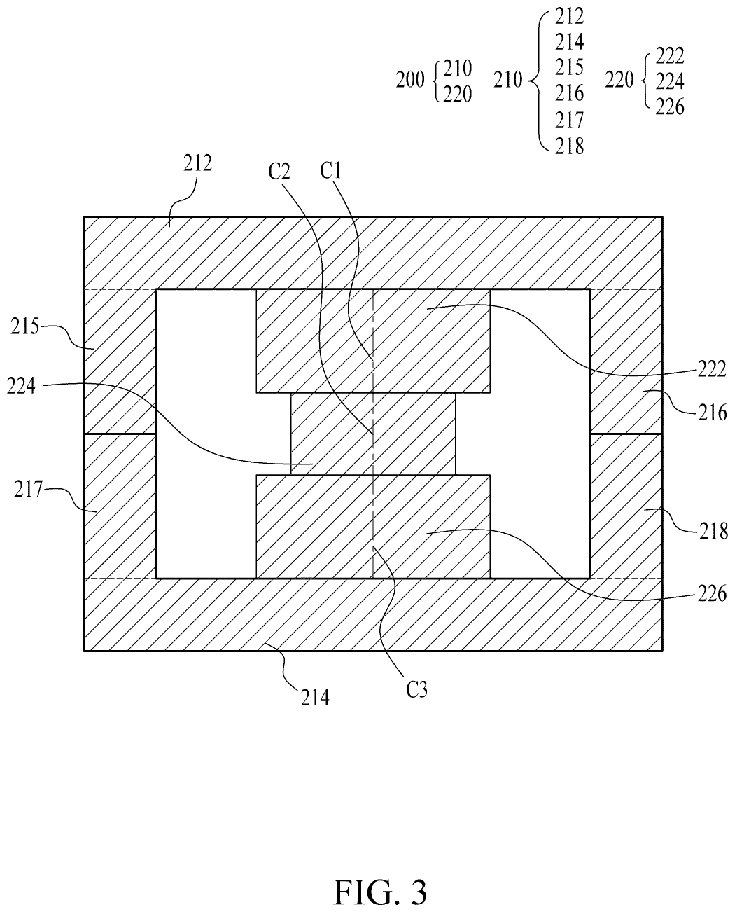

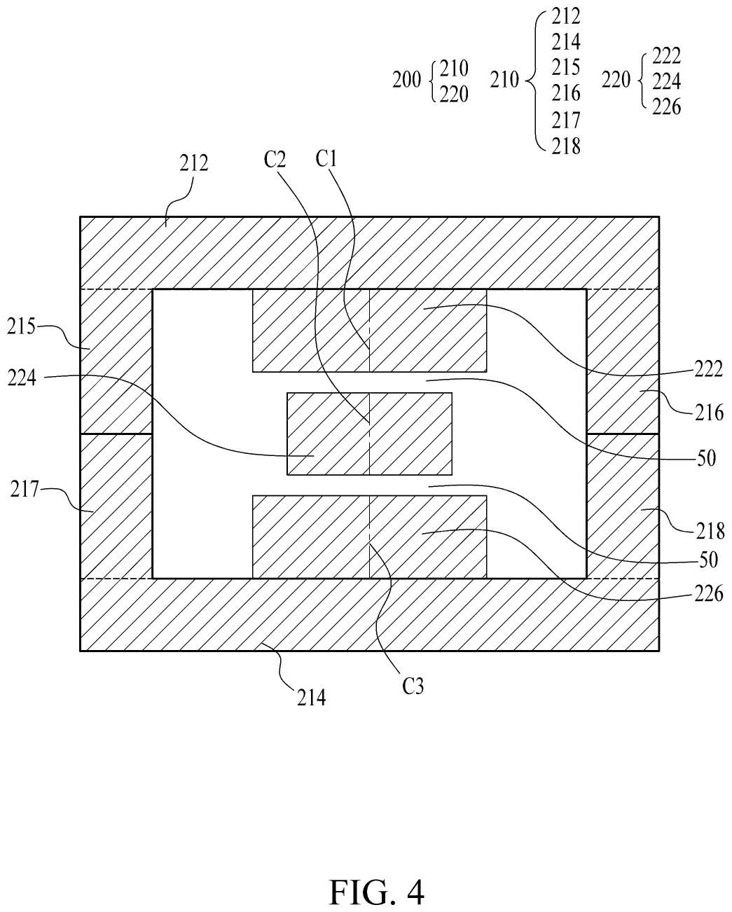

In addition, one end of the first magnetic column 222 may be connected to the first frame 212, the other end of the first magnetic column 222 may be connected to one end of the second magnetic column 224, there may be an air gap 50 between the other end of the second magnetic column 224 and one end of the third magnetic column 226, the other end of the third magnetic column 226 may be connected to the second frame 214 of the magnetic frame body 210, and the first frame 212 and the second frame 214 are opposite to each other, but this embodiment is not intended to limit the present disclosure. Please refer to FIG. 3, which is a cross-sectional view of a magnetic core structure according to an embodiment of the present disclosure. In FIG. 3, there is no air gap between the other end of the second magnetic column 224 and one end of the third magnetic column 226. Please refer to FIG. 4, which is a cross-sectional view of a magnetic core structure according to another embodiment of the present disclosure. In FIG. 4, there may also be an air gap 50 between the other end of the first magnetic column 222 and one end of the second magnetic column 224, wherein the size of the air gap 50 can be adjusted according to actual needs.

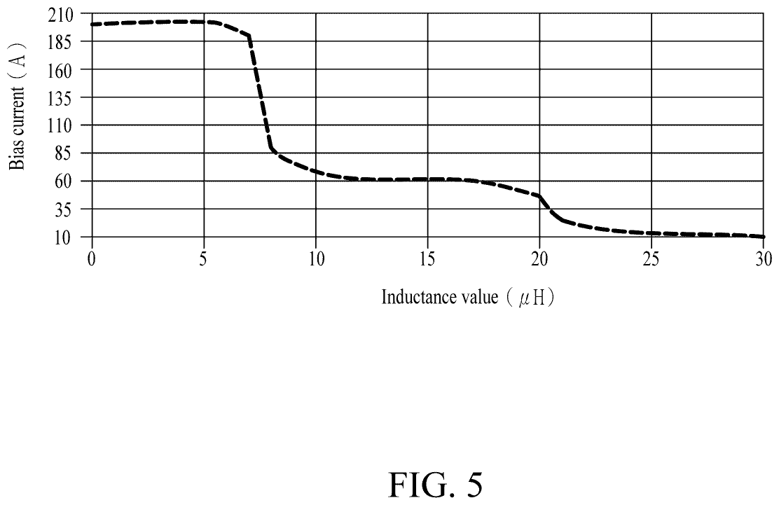

Please refer to FIG. 1, FIG. 2 and FIG. 5, wherein FIG. 5 is a graph of inductance value of the magnetic component of FIG. 1 versus bias current, the vertical axis represents the inductance value in microhenries (μH), and the horizontal axis represents the bias current in amperes (A). After the magnetic component 100 in FIG. 1 and FIG. 2 is energized, the magnetic flux in the first magnetic column 222 and the third magnetic column 226 is greater than the magnetic flux in the second magnetic column 224. Therefore, the magnetic component 100 generates the curve as shown in FIG. 5. In FIG. 5, the inductance value decreases in two stages as the bias current changes, and the inductance value changes slightly between the falling curve in the first stage and the falling curve in the second stage.

Therefore, through the special structural design of the winding column 220 (that is, the second magnetic column 224 is disposed between the first magnetic column 222 and the third magnetic column 226, the cross-sectional area of the second magnetic column 224 is smaller than the cross-sectional area of the first magnetic column 222 and the cross-sectional area of the third magnetic column 226, the projected area of the first magnetic column 222 on the first frame 212 covers the projected area of the second magnetic column 224 on the first frame 212, and the projection area of the third magnetic column 226 on the first frame 212 covers the projected area of the second magnetic column 224 on the first frame 212), when the magnetic core structure 200 is applied to the magnetic component 100, the magnetic component 100 can provide different inductance characteristics corresponding to the bias currents to meet different usage scenarios.

In one embodiment, a central axis C1 of the first magnetic column 222 coincides with a central axis C3 of the third magnetic column 226, and the central axis C1 of the first magnetic column 222 is parallel to a central axis C2 of the second magnetic column 224, as shown in FIG. 2. In another embodiment, the central axis C1 of the first magnetic column 222 coincides with the central axis C3 of the third magnetic column 226, and the central axis C1 of the first magnetic column 222 coincides with the central axis C2 of the second magnetic column 224, as shown in FIG. 3 and FIG. 4. The central axis C1 of the first magnetic column 222 refers to the axis of the geometric center of the first magnetic column 222, the central axis C2 of the second magnetic column 224 refers to the axis of the geometric center of the second magnetic column 224, and the central axis C3 of the third magnetic column 226 refers to the axis of the geometric center of the third magnetic column 226.

In one embodiment, the magnetic frame body 210 may comprise the first frame 212, a fifth frame 215 and a sixth frame 216 extending from opposite ends of the first frame 212 in a direction away from the first frame 212, the second frame 214, and a third frame 217 and a fourth frame 218 extending from opposite ends of the second frame 214 in a direction away from the second frame 214. The third frame 217 is in butt joint with the fifth frame 215, the fourth frame 218 is in butt joint with the sixth frame 216, and the first frame 212, the second frame 214, the third frame 217, the fourth frame 218, the fifth frame 215 and the sixth frame 216 form a closed magnetic loop, as shown in FIG. 2.

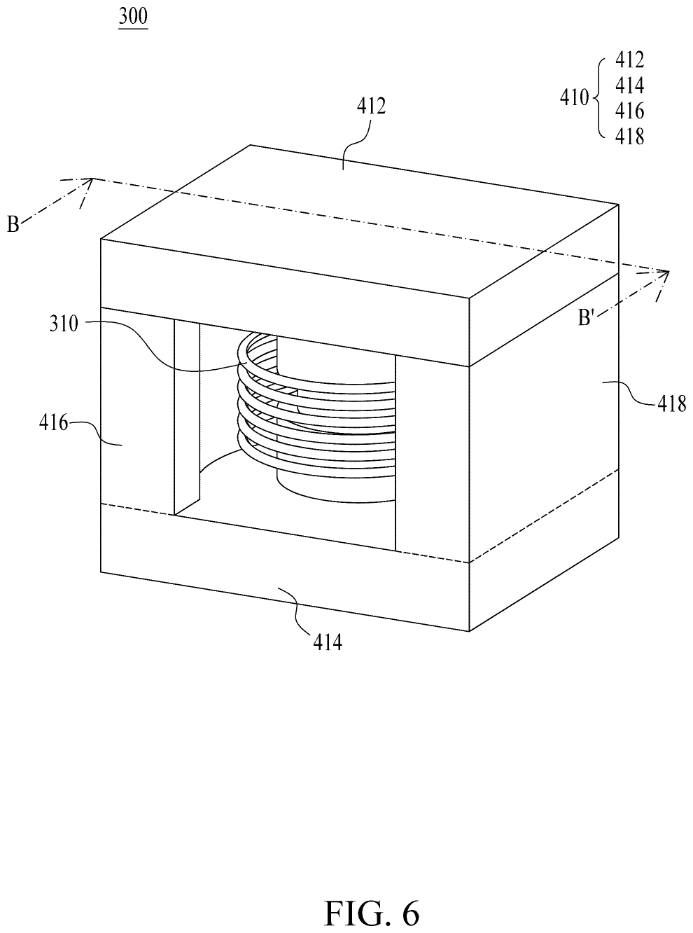

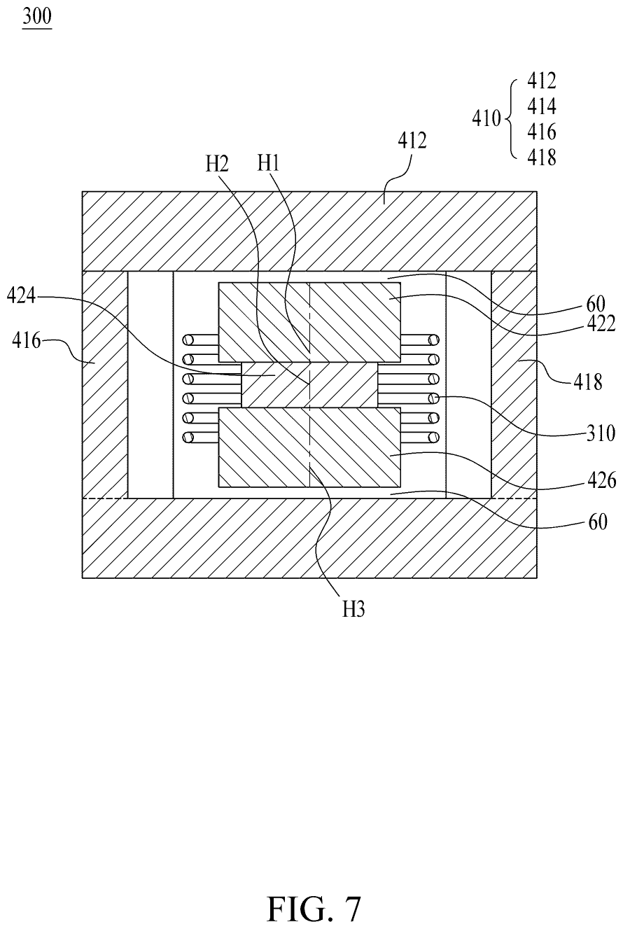

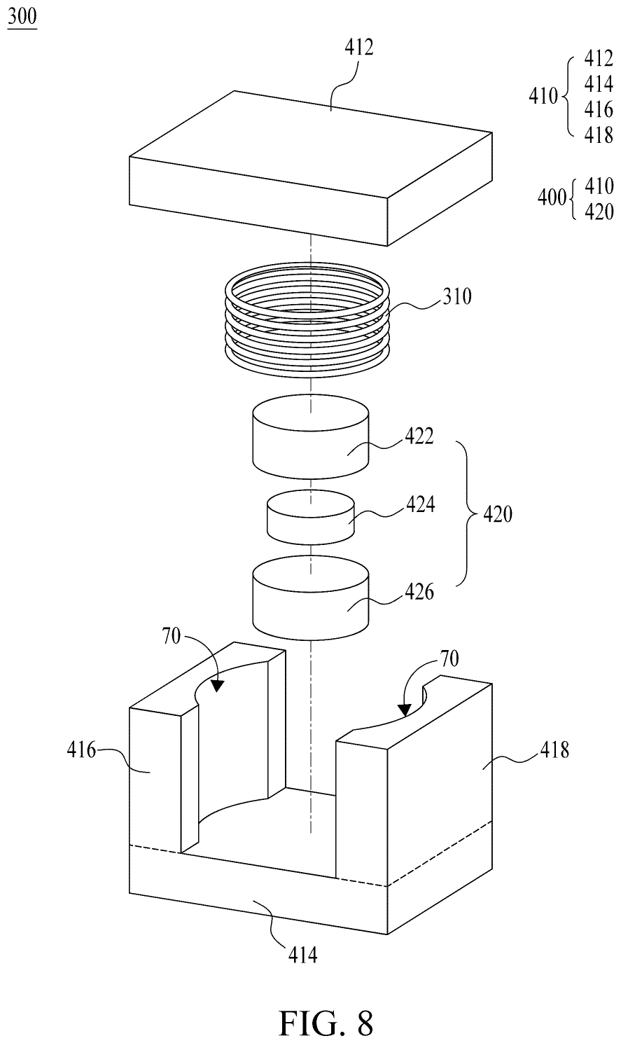

In the magnetic component 100 of FIG. 1 and FIG. 2, since the magnetic flux crosses the air gap 50, the magnetic field tends to expand in a direction perpendicular to the direction of the magnetic flux path. Therefore, the winding 110 in the magnetic component 100 of FIG. 1 and FIG. 2 is deeply affected by fringing flux, which causes heat generation and power loss in the winding 110. In order to reduce the influence of fringe flux on the winding 110, the present disclosure proposes a magnetic core structure 400 according to another embodiment. For detailed description, please refer to FIG. 6 to FIG. 8, wherein FIG. 6 is a perspective view of a magnetic component according to a second embodiment of the present disclosure, FIG. 7 is a cross-sectional view of the magnetic component of FIG. 6 along line BB', and FIG. 8 is an exploded view of the magnetic component of FIG. 6.

As shown in FIG. 6 to FIG. 8, a magnetic component 300 comprises a winding 310 and the magnetic core structure 400, wherein the magnetic component 300 may be, but is not limited to, an inductor, and the winding 310 may be, but is not limited to, made of a flat copper wire or a round copper wire. The magnetic core structure 400 comprises a magnetic frame body 410 and a winding column 420. The magnetic frame body 410 comprises a first frame 412. The winding column 420 is disposed in the magnetic frame body 410 and comprises a first magnetic column 422, a second magnetic column 424 and a third magnetic column 426. The second magnetic column 424 is disposed between the first magnetic column 422 and the third magnetic column 426. A cross-sectional area of the second magnetic column 424 is smaller than a cross-sectional area of the first magnetic column 422 and a cross-sectional area of the third magnetic column 426. A projected area of the first magnetic column 422 on the first frame 412 covers a projected area of the second magnetic column 424 on the first frame 412, and a projected area of the third magnetic column 426 on the first frame 412 covers the projected area of the second magnetic column 424 on the first frame 412.

The magnetic permeability of the second magnetic column 424 and the magnetic permeability of the magnetic frame body 410 are greater than the magnetic permeability of the first magnetic column 422 and the magnetic permeability of the third magnetic column 426. In other words, the second magnetic pillar 424 and the magnetic frame 410 may be made of, but are not limited to, the highly magnetically permeable material, such as manganese-zinc ferrite, nickel-zinc ferrite and other magnetic materials with a relative magnetic permeability of 900 to 4000; the first magnetic column 422 and the third magnetic column 426 may be made of, but are not limited to, the low magnetic permeability material, such as iron-silicon-aluminum alloy (Sendust), high magnetic flux iron-nickel alloy, molypermalloy powder (MPP), and other magnetic materials with a relative magnetic permeability of 26 to 160.

In addition, there may be an air gap 60 between one end of the first magnetic column 422 and the first frame 412, the other end of the first magnetic column 422 may be connected to one end of the second magnetic column 424, the other end of the second magnetic column 424 may be connected to one end of the third magnetic column 426, there may be an air gap 60 between the other end of the third magnetic column 426 and a second frame 414 of the magnetic frame body 410, the first frame 412 and the second frame 414 are opposite to each other, but this embodiment is not intended to limit the present disclosure. For example, there may be an air gap between the first magnetic column 422 and the magnetic frame body 410, between the first magnetic column 422 and the second magnetic column 424, between the second magnetic column 424 and the third magnetic column 426, and/or between the third magnetic column 426 and the magnetic frame body 410; or the first magnetic column 422, the second magnetic column 424 and/or the third magnetic column 426 may be composed of multiple sub-magnetic columns and may comprise an air gap. In other words, the winding column 420 may comprise at least one air gap 60. The size of the air gap 60 can be adjusted according to actual needs.

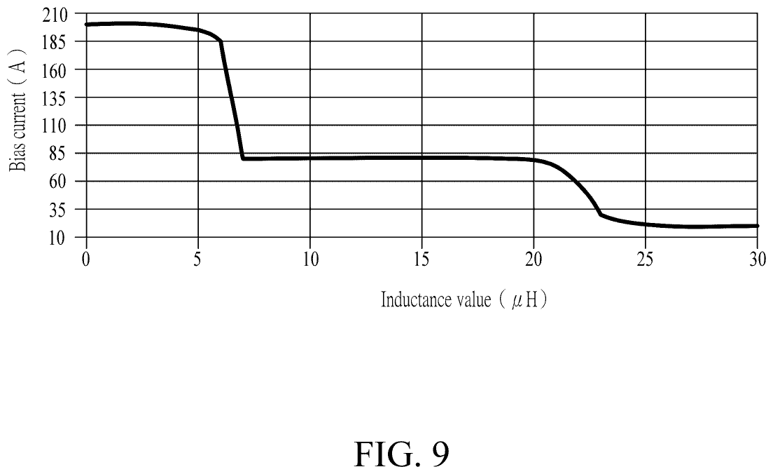

Please refer to FIG. 6, FIG. 7 and FIG. 9, wherein FIG. 9 is a graph of inductance of the magnetic component of FIG. 6 versus bias current, the vertical axis represents the inductance value in microhenries (μH), and the horizontal axis represents the bias current in amperes (A). After the magnetic component 300 in FIG. 6 and FIG. 7 is energized, the lines of magnetic force in the first magnetic column 422 and the third magnetic column 426 are greater than the lines of magnetic force in the second magnetic column 424. Therefore, the magnetic component 300 generates a curve as shown in FIG. 9. In FIG. 9, the inductance value decreases in two stages as the bias current changes, and the inductance value remains unchanged between the falling curve in the first stage and the falling curve in the second stage. Thus, through the special structural design of the winding column 420, when the magnetic core structure 400 is applied to the magnetic component 300, the magnetic component 300 can provide different inductance characteristics corresponding to the bias currents to meet different usage scenarios. In addition, since there is no air gap between the first magnetic column 422 and the second magnetic column 424 and between the second magnetic column 424 and the third magnetic column 426, the winding 310 is less affected by fringing flux than the winding 110 in FIG. 2, which can reduce the power loss of the winding 310.

In one embodiment, a central axis H1 of the first magnetic column 422 coincides with a central axis H3 of the third magnetic column 426, and the central axis H1 of the first magnetic column 422 coincides with a central axis H2 of the second magnetic column 424, as shown in FIG. 7, wherein the central axis H1 of the first magnetic column 422 refers to the axis of the geometric center of the first magnetic column 422, the central axis H2 of the second magnetic column 424 refers to the axis of the geometric center of the second magnetic column 424, and the central axis H3 of the third magnetic column 426 refers to the axis of the geometric center of the third magnetic column 426.

In one embodiment, the magnetic frame body 410 may comprise the first frame 412, the second frame 414, and a third frame 416 and a fourth frame 418 extending from opposite ends of the second frame 414 in a direction away from the second frame 414. The third frame 416 and the fourth frame 418 connect the opposite ends of the first frame 412. The first frame 412, the second frame 414, the third frame 416 and the fourth frame 418 form a closed magnetic loop.

In one embodiment, the first magnetic column 422, the second magnetic column 424 and the third magnetic column 426 are all of cylindrical structures, and the magnetic frame body 410 may further comprise the third frame 416 and the fourth frame 418. The third frame 416 and the fourth frame 418 are disposed at opposite ends of the first frame 412. The third frame 416 and the fourth frame 418 have arc surfaces 70 facing the winding columns 420.

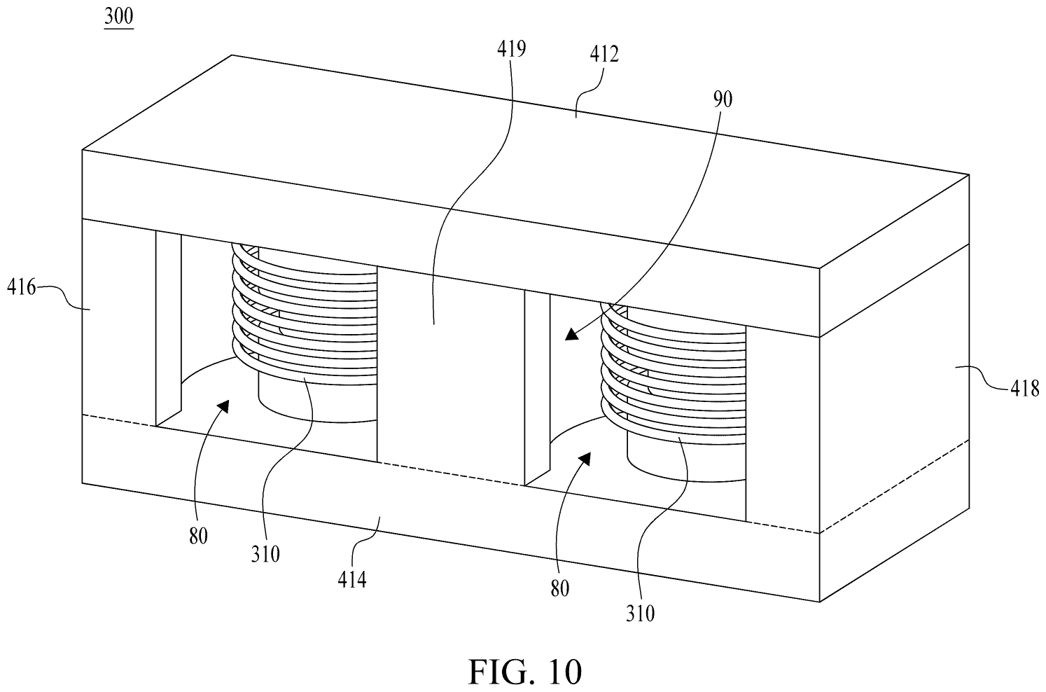

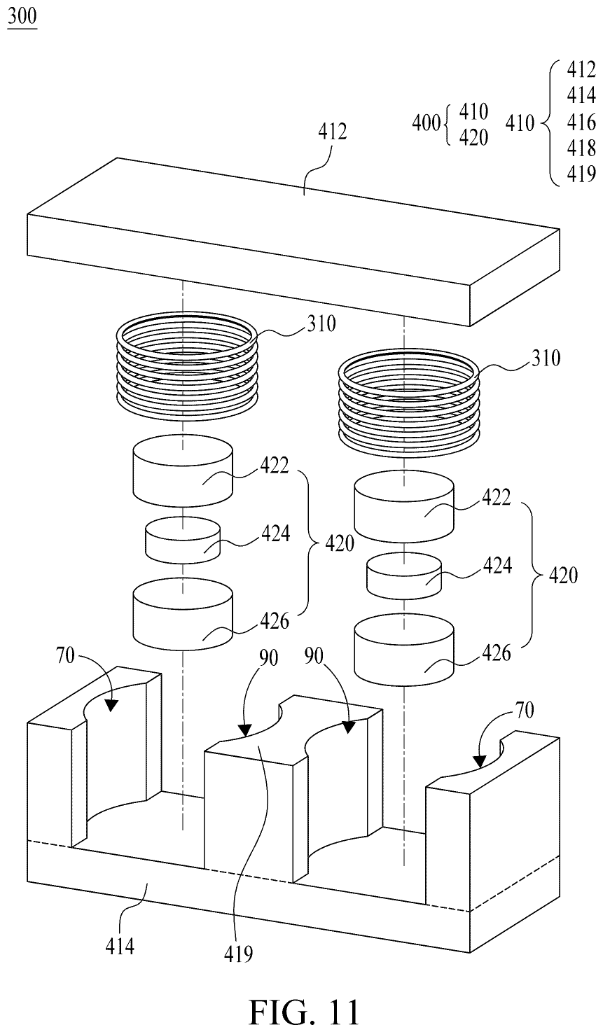

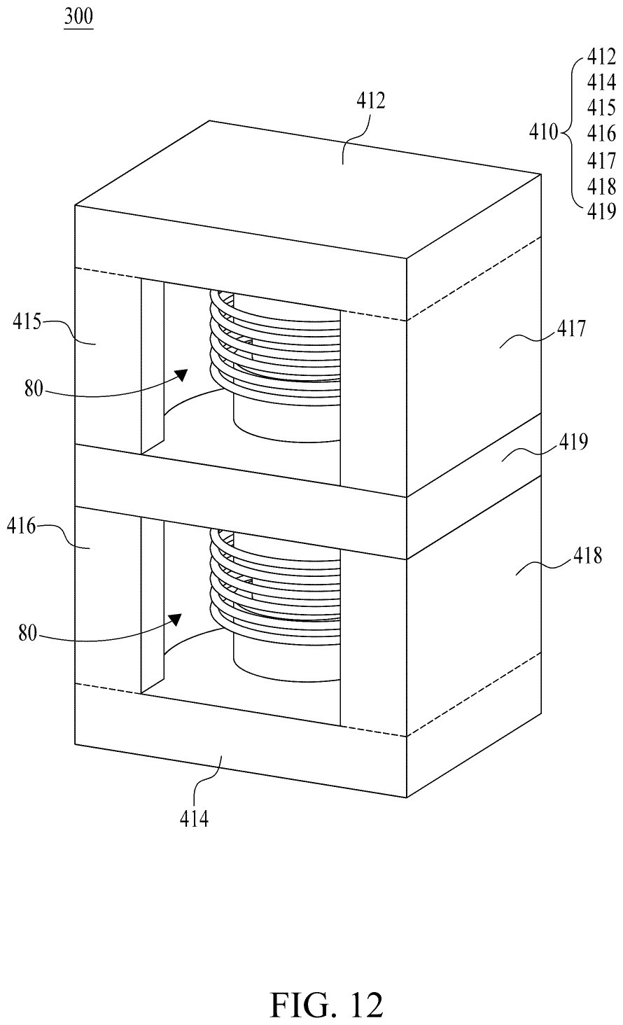

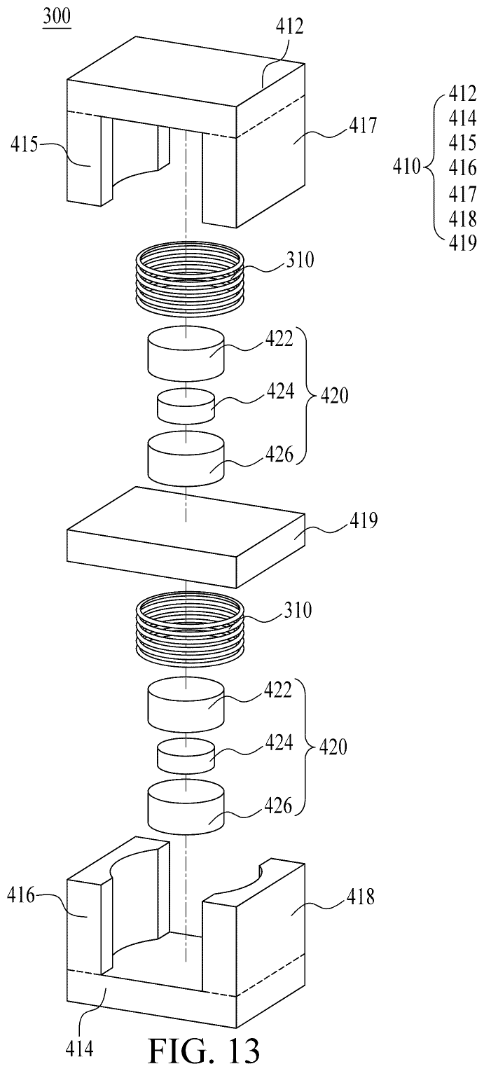

In one embodiment, the number of winding columns 420 may be N, the magnetic frame body 410 may comprise N−1 partitions 419, and the N−1 partitions 419 are configured to partition the magnetic frame body 410 into N accommodating cavities 80, the N winding columns 420 are arranged one-to-one in the N accommodating cavities 80, and N is a positive integer and greater than or equal to 2, as shown in FIG. 10 to FIG. 13, wherein FIG. 10 is a perspective view of a magnetic component according to a third embodiment of the present disclosure, FIG. 11 is an exploded view of the magnetic component of FIG. 10, FIG. 12 is a perspective view of a magnetic component according to a fourth embodiment of the present disclosure, and FIG. 13 is an exploded view of the magnetic component of FIG. 12. In FIG. 10 to FIG. 13, the number of winding columns 420 may be two, and the magnetic frame body 410 may comprise one partition 419, which is used to partition the magnetic frame body 410 into two accommodating cavities 80. Through the design of the magnetic core structure 400 integrating the magnetic cores of multiple inductors (that is, the winding columns 420 are arranged one-to-one in the accommodation cavities 80), the volume of the magnetic core structure 400 is smaller than the volume of the magnetic cores of multiple discretely arranged inductors, which conforms to a miniaturization development trend.

In one embodiment, the axes of the winding columns 420 are parallel to each other (as shown in FIG. 10 and FIG. 11) or coincide with each other (as shown in FIG. 12 and FIG. 13). The axis of each winding column 420 may be, but is not limited to, an extension line of the central axis of each winding column 420.

In one embodiment, when the first magnetic column 422, the second magnetic column 424 and the third magnetic column 426 are all of cylindrical structures, and the axes of the winding columns 420 are parallel to each other, and both sides of the partition 419 are provided with an arcuate surface 90 facing the adjacent winding column 420, as shown in FIG. 10 and FIG. 11.

In one embodiment, when the axes of the winding columns 420 coincide with each other, the partition 419 is a plate, and the partition 419 is arranged parallel to the first frame 412 and perpendicular to the axes of the winding columns 420, as shown in FIG. 12 and FIG. 13.

Please refer to FIG. 12 and FIG. 13, the magnetic frame body 410 may comprise the first frame 412, the fifth frame 415 and the sixth frame 417 extending from opposite ends of the first frame 412 in a direction away from the first frame 412, the second frame 414, the third frame 416 and the fourth frame 418 extending from opposite ends of the second frame 414 in a direction away from the second frame 414, and the partition 419. The third frame 416, the fourth frame 418, the fifth frame 415 and the sixth frame 417 are connected to the partition 419. The partition 419, the first frame 412 and the second frame 414 are arranged in parallel. The first frame 412, the fifth frame 415, the sixth frame 417 and the partition 419 form an accommodating cavity 80, and the second frame 414, the third frame 416, the fourth frame 418 and the partition 419 form another accommodating cavity 80.

In summary, in the embodiments of the present disclosure, through the special structural design of the winding column (that is, the second magnetic column is disposed between the first magnetic column and the third magnetic column, the cross-sectional area of the second magnetic column is smaller than the cross-sectional area of the first magnetic column and the cross-sectional area of the third magnetic column, the projected area of the first magnetic column on the first frame covers the projected area of the second magnetic column on the first frame, and the projection area of the third magnetic column on the first frame covers the projected area of the second magnetic column on the first frame), when the magnetic core structure is applied to the magnetic component (i.e., inductors), the magnetic component can provide different inductance characteristics corresponding to the bias currents to meet different usage scenarios.

While the present disclosure is disclosed in the foregoing embodiments, it should be noted that these descriptions are not intended to limit the present disclosure. On the contrary, the present disclosure covers modifications and equivalent arrangements obvious to those skilled in the art. Therefore, the scope of the claims must be interpreted in the broadest manner to comprise all obvious modifications and equivalent arrangements.

What is claimed is:

1. A magnetic core structure, comprising:
a magnetic frame body comprising a first frame; and
a winding column disposed in the magnetic frame, and comprising a first magnetic column, a second magnetic column and a third magnetic column, wherein the second magnetic column is disposed between the first magnetic column and the third magnetic column, a cross-sectional area of the second magnetic column is smaller than a cross-sectional area of the first magnetic column and a cross-sectional area of the third magnetic column, a projected area of the first magnetic column on the first frame covers a projected area of the second magnetic column on the first frame, and a projected area of the third magnetic column on the first frame covers the projected area of the second magnetic column on the first frame.

2. The magnetic core structure according to claim 1, wherein one end of the first magnetic column is connected to the first frame, the other end of the first magnetic column is connected to one end of the second magnetic column, there is an air gap between the other end of the second magnetic column and one end of the third magnetic column, the other end of the third magnetic column is connected to a second frame of the magnetic frame body, and the first frame and the second frame are opposite to each other.

3. The magnetic core structure according to claim 1, wherein a central axis of the first magnetic column coincides with a central axis of the third magnetic column, and the central axis of the first magnetic column coincides with or is parallel to a central axis of the second magnetic column.

4. The magnetic core structure according to claim 1, wherein there is an air gap between one end of the first magnetic column and the first frame, the other end of the first magnetic column is connected to one end of the second magnetic column, the other end of the second magnetic column is connected to one end of the third magnetic column, there is another air gap between the other end of the third magnetic column and a second frame of the magnetic frame body, and the first frame and the second frame are opposite to each other.

5. The magnetic core structure according to claim 1, wherein a magnetic permeability of the second magnetic column and a magnetic permeability of the magnetic frame body are greater than a magnetic permeability of the first magnetic column and a magnetic permeability of the third magnetic column.

6. The magnetic core structure according to claim 5, wherein there is an air gap between the first magnetic column and the magnetic frame body, between the first magnetic column and the second magnetic column, between the second magnetic column and the third magnetic column, and/or between the third magnetic column and the magnetic frame body.

7. The magnetic core structure according to claim 1, wherein the winding column comprises at least one air gap.

8. The magnetic core structure according to claim 1, wherein the first magnetic column, the second magnetic column and the third magnetic column are all of cylindrical structures, the magnetic frame body further comprises a third frame and a fourth frame, the third frame and the fourth frame are arranged at opposite ends of the first frame, and each of the third frame and the fourth frame has an arc-shaped surface facing the winding column.

9. The magnetic core structure according to claim 1, wherein the magnetic frame body further comprises a second frame, and a third frame and a fourth frame extending from opposite ends of the second frame in a direction away from the second frame, the third frame and the fourth frame connect opposite ends of the first frame, and the first frame, the second frame, the third frame and the fourth frame form a closed magnetic loop.

10. The magnetic core structure according to claim 1, wherein the magnetic frame body further comprises a fifth frame and a sixth frame extending from opposite ends of the first frame in a direction away from the first frame, a second frame, and a third frame and a fourth frame extending from opposite ends of the second frame in a direction away from the second frame, the third frame is in butt joint with the fifth frame, the fourth frame is in butt joint with the sixth frame, and the first frame, the second frame, the third frame, the fourth frame, the fifth frame and the sixth frame form a closed magnetic loop.

11. The magnetic core structure according to claim 1, wherein the number of the winding columns is N, the magnetic frame body comprises N−1 partitions, the N−1 partitions are configured to partition the magnetic frame body into N accommodating cavities, the N winding columns are arranged one-to-one in the N accommodating cavities, and N is a positive integer and greater than or equal to 2.

12. The magnetic core structure according to claim 11, wherein axes of the N winding columns are parallel to or coincide with each other.

13. The magnetic core structure according to claim 12, wherein when the first magnetic column, the second magnetic column and the third magnetic column are all of cylindrical structures and the axes of the N winding columns are parallel to each other, and both sides of each partition are provided with an arcuate surface facing an adjacent winding column.

14. The magnetic core structure according to claim 12, wherein when the axes of the N winding columns coincide with each other, the N−1 partitions are plates, and the N−1 partitions are arranged parallel to the first frame and perpendicular to the axes of the N winding columns.
